(19) United States
(12) Patent Application Publication
(10) Pub. No.: US 2008/0244267 A1
(43) Pub. Date: Oct. 2, 2008

(54) Local and remote access control of a resource

(75) Inventors: Vincent J. Zimmer, Federal Way, WA (US); Burges M. Karkaria, San Jose, CA (US); Rahul Khanna, Beaverton, OR (US); Yufu Li, Shanghai (CN)

Correspondence Address: INTEL CORPORATION;c/o INTELLEVATE, LLC, P.O. BOX 52050, MINNEAPOLIS, MN, 55402, US

(73) Assignee: INTEL CORPORATION

(21) Appl. No.: 11/731,433

(22) Filed: Mar. 30, 2007

(51) Int. Cl. H04L 9/32

(52) U.S. Cl. 713/171; 726/17

(57) ABSTRACT

Embodiments of the invention are generally directed to systems, methods, and apparatuses for local and remote access to a resource. In some embodiments, an integrated circuit includes a configurable hardware resource. In addition, the integrated circuit may also include access control logic to authenticate agents that attempt to configure the resource. In some embodiments, the agents may be in-band or out-of-band agents. Other embodiments are described and claimed.

### TECHNICAL FIELD

Embodiments of the invention generally relate to the field of integrated circuits and, more particularly, to systems, methods and apparatuses for local and remote access control of a resource.

### BACKGROUND

Processors and chipsets typically include on-die hardware components that are configured before (or while) a computer's operating system is booted. In “many core” systems, these components include, for example, system address decoders, router table arrays, and other components that support the interconnection of cores. These configurable components are vulnerable to errant and malicious programming.

In conventional systems, access to configurable hardware resources is frequently determined by the mode of a system. For example, certain registers might only be written to if the system is in a system management mode. In addition, conventional systems may allow nearly any out-of-band agent to configure hardware resources, if the out-of-band agent uses a particular communication path (e.g., a system management bus).

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a high-level block diagram illustrating selected aspects of a computing system implemented according to an embodiment of the invention.

FIG. 2 is a block diagram illustrating selected aspects of a many core computing system having access control logic according to an embodiment of the invention.

FIG. 3 is a block diagram illustrating selected aspects of a cryptographic protocol suitable for use with access control logic according to an embodiment of the invention.

FIG. 4 is a flow diagram illustrating selected aspects of a method for access control of configuration hardware, according to an embodiment of the invention.

FIG. 5 is a block diagram illustrating selected aspects of local and remote access control, according to an embodiment of the invention.

### DETAILED DESCRIPTION

Embodiments of the invention are generally directed to systems, methods, and apparatuses for local and remote access control of configurable hardware. In some embodiments, an integrated circuit includes logic to control the access to configurable resources such as control and status registers, router table arrays, core enable/disable logic, and the like. As is further discussed below, in some embodiments, the access control logic uses a cryptographic authentication protocol to regulate access to configurable hardware.

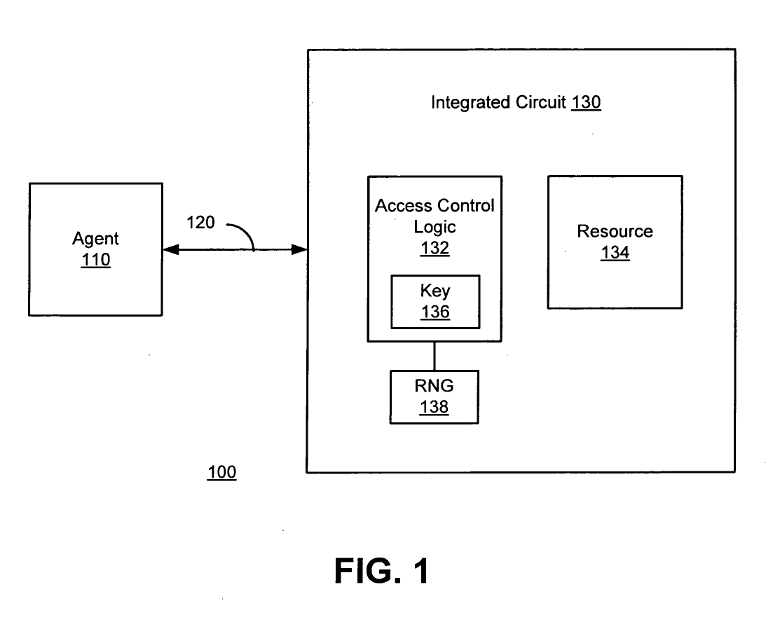

FIG. 1 is a high-level block diagram illustrating selected aspects of a computing system implemented according to an embodiment of the invention. System 100 includes agent 110 and integrated circuit 130 coupled together via interconnect 120. Agent 110 may be either an in-band or an out-of-band agent that is capable of configuring resource 134. In-band agents include, for example, platform firmware that configures the system during startup. Out-of-bound agents include, for example, remote management servers that connect with integrated circuit 130 over a network. Interconnect 120 may be nearly any combination of wired or wireless interconnects suitable for transferring information between electronic devices.

Integrated circuit 130 includes, inter alia, access control logic 132 and resource 134. Resource 134 may be nearly any configurable hardware resource or an element of a configurable hardware resource. For example, resource 134 may be a control and status register, a processor core, a graphics core, a model specific register, an accelerator, and the like.

Access control logic 132 authenticates an agent (e.g., agent 110) that attempts to configure resource 134. The term “authenticates” broadly refers to requiring evidence that an agent is authorized to configure resource 134. In some embodiments, access control logic 132 implements a cryptographic authentication protocol to authenticate the agent. In such embodiments, access control logic 132 may be provisioned with key 136. For example, during manufacturing, soft fuses may be blown to provision key 136. Alternatively, a different provisioning mechanism may be used. Key 136 may be, for example, a private key of a cryptographic public/private key pair. For ease of illustration, key 136 is illustrated as being part of access control logic 132. It is to be appreciated, however, that key 136 may located nearly anywhere on integrated circuit 130 or may be located on a different integrated circuit.

In some embodiments, access control logic 132 exchanges a nonce with agent 110, as part of the cryptographic authentication protocol to, for example, prevent (or attempt to prevent) replay attacks. In such embodiments, integrated circuit 130 may include random number generator (RNG) 138 to provide the nonce. In alternative embodiments, RNG 138 may be located on a different integrated circuit.

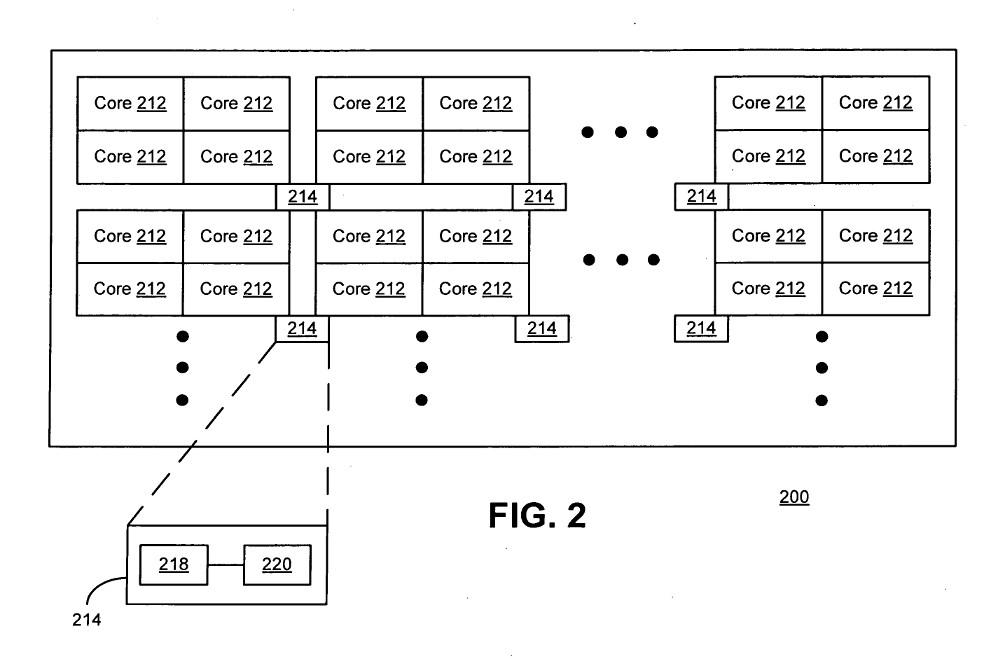

FIG. 2 is a block diagram illustrating selected aspects of a many core computing system having access control logic according to an embodiment of the invention. System 200 includes a number of cores 212 which are interconnected by routing logic 214. Cores 212 may be general purpose processor cores, graphics cores, and the like. It is to be appreciated that system 200 may include nearly any number of cores (e.g., 2, 4, 8, 16, 32, 64, 128, etc.).

Routing logic 214 may include the address decoders and/or route tables that are used to interconnect cores 212. Various aspects of routing logic 214 may be configurable. For example, how physical addresses are decoded may be configurable and/or the values in the route tables may be configurable.

In some embodiments, at least some of the instances of routing logic 214 include access control logic 218 and CSR 220. Access control logic 218 determines whether an agent is authorized to change the values stored in CSR 220. In some embodiments, access control logic 218 requires that an agent seeking to access CSR 220 provides a public key matching a private key that was previously provisioned within system 200. In alternative embodiments, a different mechanism may be used to authenticate an agent. As is further described below, in some embodiments, access control logic 218 uses a cryptographic authentication protocol to authenticate an agent. In some embodiments, access control logic 218 is implemented, at least in part, in hardware. In alternative embodiments, access control logic 218 may be implemented, at least in part, in platform microcode.

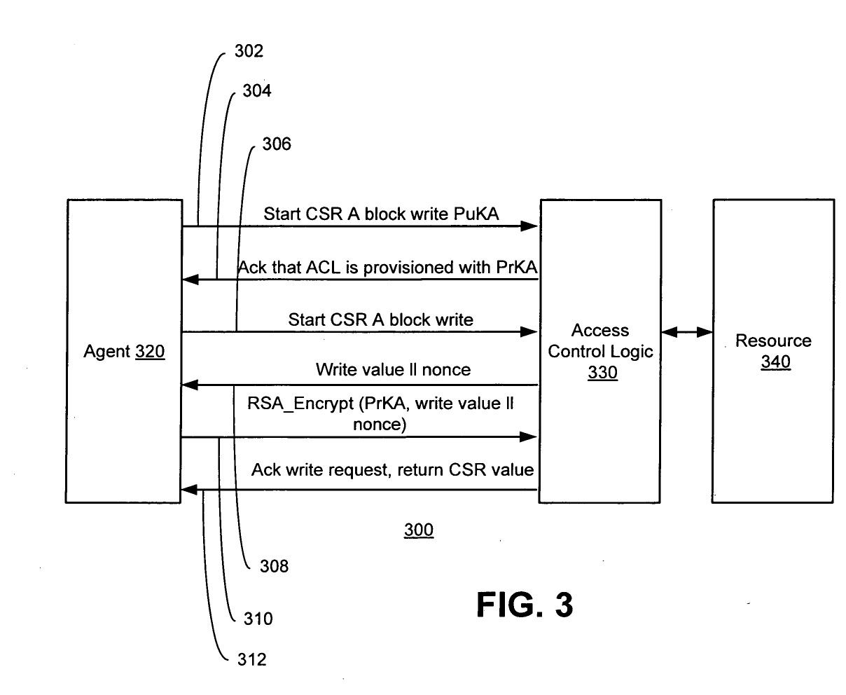

FIG. 3 is a block diagram illustrating selected aspects of a cryptographic protocol suitable for use with access control logic according to an embodiment of the invention. Agent 320 starts a block write to a resource 340 (e.g., a control and status register (CSR)) at 302. In some embodiments, agent 320 provides a public key (PuKA) to demonstrate that it is authorized to write data to the CSR.

Access control logic 330 determines whether the PuKA matches a private key (PrKA) that was previously provisioned on the platform with which access control logic 330 is associated. If the PuKA matches the PrKA, then access control logic 330 acknowledges that agent 320 can write to the CSR at 304 (without disclosing the PrKA).

Agent 320 starts a block write to the CSR at 306. In some embodiments, access control logic 330 returns at least a portion of the write data and a nonce at 308. The nonce can be used to protect against a replay attack by providing an indication that this is a “fresh” transaction. For example, in the illustrated embodiment, agent 320 encrypts the write value and the nonce and provides it to access control logic 330 at 310. Access control logic 330 acknowledges the write request (and returns the CSR value) at 312. In alternative embodiments, the encryption protocol may have more elements, fewer elements, different elements, and/or may occur in a different order.

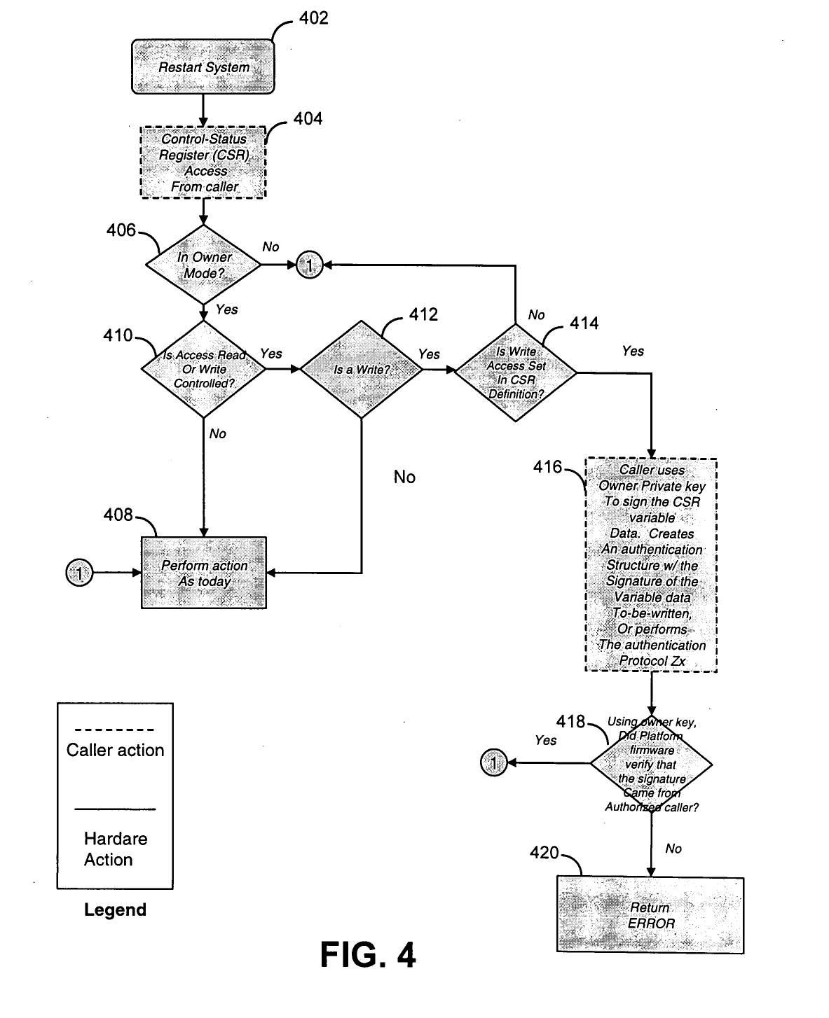

FIG. 4 is a flow diagram illustrating selected aspects of a method for access control of configurable hardware, according to an embodiment of the invention. A computer system restarts at 402. During system initiation, an agent attempts to access a CSR at 404. In some embodiments, the agent may be an in-bound agent or an out-of-band agent.

If the system is not in an owner mode then, in some embodiments, initialization may proceed in a substantially conventional manner (e.g., 406 and 408). If, however, the system is in an owner mode, then access control logic (ACL) determines whether the CSR is access controlled at 410. The ACL determines whether the agent is attempting to write to the CSR at 412. If the agent is attempting to write to the CSR, then the ACL may determine whether write access is set at 414.

If write access is set, then the agent may use an encryption protocol to write data to the CSR as shown by 416 and 418. In some embodiments, the agent may use an encryption protocol that is substantially similar to the protocol described above with reference to FIG. 3 (e.g., the Zimmer eXecution or Zx Protocol). In alternative embodiments, a different communication protocol may be used. If the ACL determines that the agent is not authorized to configure the CSR, then it may return an ERROR as shown by 420.

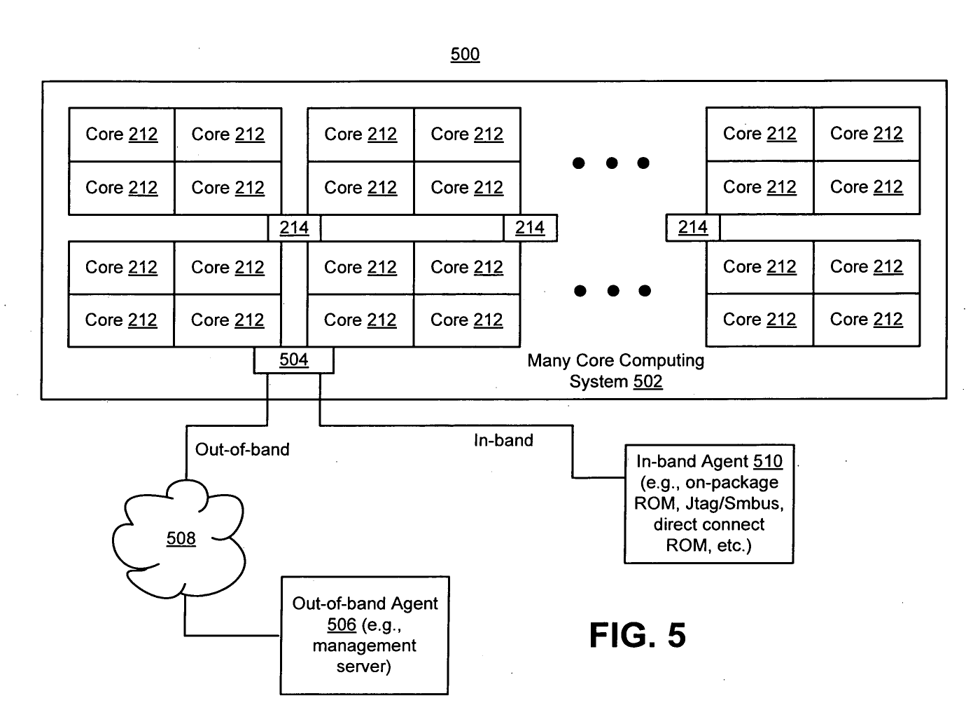

FIG. 5 is a block diagram illustrating selected aspects of local and remote access control, according to an embodiment of the invention. System 500 includes a many core computing system that may be substantially similar to the many core system discussed above with reference to FIG. 2. In some embodiments, access control logic (ACL) 504 determines whether out-of-band agents and/or in-band agents are authorized to access configurable hardware elements of computing system 502.

Out-of-band (OOB) agent 506 may be any of wide variety of remote agents capable of configuring one or more hardware resources of computer system 502. In some embodiments, OOB 506 is a management server. Since ACL 502 can authenticate OOB agent 506, the configuration of hardware resources can be delegated beyond traditional schemes such as the system management bus. Rather, OOB 506 can access system 502 over nearly any wired and/or wireless communication path (e.g., via network 508) and authenticate itself to ACL 502. Thus, an original equipment manufacturer (OEM) can be brought within the “trust perimeter” by provisioning an integrated circuit (e.g., a processor die, chipset, etc.) with its own encryption key during, for example, manufacturing.

In-band agent 510 may be any of a wide variety of local agents including, for example, on-package read only memory (ROM), agents that use JTag/SMbus, direct connect ROM, and the like. In some embodiments, in-band agent 510 configures one or more hardware resources of system 502 during initiation.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

What is claimed is:

1. An integrated circuit comprising:
a resource; and
access control logic coupled with the resource, the access control logic to determine whether an agent is authorized to access the resource.

2. The integrated circuit of claim 1, wherein the access control logic to determine whether the agent is authorized to access the resource comprises:
logic to implement an authentication protocol to control access to the resource.

3. The integrated circuit of claim 2, wherein the logic to implement the authentication protocol comprises:
logic to implement a cryptographic authentication protocol.

4. The integrated circuit of claim 3, wherein the logic to implement the authentication protocol comprises:
logic to provide a nonce to the agent.

5. The integrated circuit of claim 1, wherein the agent is an out-of-band agent.

6. The integrated circuit of claim 1, wherein the agent is an in-band agent.

7. The integrated circuit of claim 1, wherein the resource comprises at least one of:
a control and status register,
a processor core,
a graphics core,
a model specific register, and
a system address decoder.

8. The integrated circuit of claim 1, wherein the access control logic is implemented, at least in part, in hardware.

9. The integrated circuit of claim 1, wherein the access control logic is implemented, at least in part, in platform microcode.

10. A method comprising:
receiving an indication that an agent is attempting to write a value to a resource, wherein the indication includes a public key associated with an authentication protocol;
acknowledging that the resource is provisioned with a private key corresponding to the public key;
receiving a write value from the agent;
returning the write value and a nonce to the agent;
receiving encrypted information from the agent, wherein the encrypted information includes the write value and the nonce;
updating the resource based, at least in part, on the encrypted information.

11. The method of claim 10, further comprising:
acknowledging that the agent provided the encrypted information.

12. The method of claim 10, wherein the agent is an out-of-band agent.

13. The method of claim 10, wherein the agent is an in-band agent.

14. The method of claim 10, wherein the resource comprises at least one of:
a control and status register,
a processor core,
a graphics core,
a model specific register, and
a system address decoder.

15. A system comprising:
an integrated circuit including
a resource, and
access control logic coupled with the resource, the access control logic to determine whether an agent is authorized to access the resource; and
a non-volatile memory device coupled with the integrated circuit.

16. The system of claim 15, wherein the access control logic to determine whether the agent is authorized to access the resource comprises:
logic to implement an authentication protocol to control access to the resource.

17. The system of claim 16, wherein the logic to implement the authentication protocol comprises:
logic to provide a nonce to the agent.

18. The system of claim 15, wherein the agent is an out-of-band agent.

19. The system of claim 15, wherein the agent is an in-band agent.

20. The system of claim 15, wherein the resource comprises at least one of:
a control and status register,
a processor core,
a graphics core,
a model specific register, and
a system address decoder.
